(19) United States
(12) Patent Application Publication
(10) Pub. No.: US 2016/0097001 A1
(43) Pub. Date: Apr. 7, 2016

(54) APPARATUS AND METHOD EMPLOYING MICROWAVE HEATING OF HYDROCARBON FLUID

(71) Applicant: Schlumberger Technology Corporation, Sugar Land, TX (US)

(72) Inventors: Wai-Ming Tam, Sugar Land, TX (US); Shawn David Taylor, Edmonton (CA); Brian Oliver Clark, Sugar Land, TX (US)

(21) Appl. No.: 14/508,705

(22) Filed: Oct. 7, 2014

(51) Int. Cl. C10G 9/00; B01J 19/12

(52) U.S. Cl. CPC C10G 9/007; B01J 19/129; B01J 19/126; B01J 2219/0871; B01J 2219/1281; B01J 2219/1293

(57) ABSTRACT

Apparatus for heating of hydrocarbon fluid where a traveling waveguide structure is configured to confine traveling wave electromagnetic radiation within its interior chamber and to contain hydrocarbon fluid that is subject to heating by such traveling wave electromagnetic radiation. The apparatus can be configured to heat hydrocarbon fluid to a reaction temperature suitable for visbreaking of the hydrocarbon fluid. The reaction temperature can be in the range of 350° C. to 500° C., which is suitable for visbreaking of heavy oil.

### BACKGROUND

1. Field

The present application relates generally to thermal processing of materials. More particularly, the present application relates to the use of electromagnetic radiation (such as microwave radiation) to promote a chemical process or reaction, such as visbreaking of a hydrocarbon fluid where the molecular bonds in hydrocarbon molecules are broken so that smaller or lighter hydrocarbons are created in order to irreversibly reduce the viscosity of the hydrocarbon fluid.

2. Description of Related Art

While heavy oil is becoming a regular feedstock to most refineries, its inherent high viscosity presents a challenge in transporting the heavy oil from the wellsite to commercial upgrading and refining facilities. A number of options have been or are currently used, including tanker shipments by rail, tanker truck, or barge, diluting of the heavy oil for pipeline transportation, and viscosity reduction by visbreaking for pipeline transportation.

The most common method of transport is blending heavy oils with diluents to reduce the viscosity to a lower value that makes pipeline transport of the heavy oil technically and economically feasible. The diluents may be solvents, condensate liquids, naphtha, or light conventional oils that are compatible with the heavy oils. Such methods require large and readily available volumes of diluents as well as infrastructure to blend, transport, and recover the diluents at the other end of the pipeline. Since the costs of diluents and pumping additional volumes of liquid can be significant, other viscosity reduction methods that can be deployed at a wellsite location prior to pipeline transport are attractive.

Other approaches to reduce the viscosity at the wellsite can involve chemically altering the composition of the heavy oil using a visbreaking process deployed within a surface facility (e.g., gas-fired visbreaker) or by in-situ upgrading techniques (e.g., electromagnetic (EM) heating techniques at radiowave (RF) or microwave (MW) frequencies).

Heavy oil has a high molecular weight fraction (which can be referred to as a residual fraction) that distills at temperatures above 524° C. Visbreaking involves heating the heavy oil to a reaction temperature (for example, in the range of 350° C. to 500° C.) where thermal cracking of the heavy oil will take place with relatively low conversion of the residual fraction. It is commonplace that no more than 30 percent of the residual fraction of the heavy oil is converted, with the result being that just enough material is converted to reduce the viscosity but not significantly alter the quality of the heavy oil. Note that visbreaking is a different process than conventional upgrading (e.g., delayed cokers and fluidized bed cokers) where the composition of the feedstock is significantly altered to produce a higher quality oil for refining. Moreover, the conventional upgrading process can handle large production volumes in the range of ten thousand to hundreds of thousands of barrels/day and can require expensive infrastructure to be viable and is therefore limited to refinery locations. However, visbreaking techniques at wellsite surface facilities can be more attractive for preparing pipeline ready heavy oils since the production volumes are lower and such techniques involve reduced and simplified infrastructure.

Visbreaking can be carried out by a gas-fired heated tubular reactor that provides directional heating from outside to inside (i.e. heat flow from the tube wall to the oil contained inside the tube). While effective and relatively efficient, this mechanism introduces the risk of thermally-driven fouling on the inside of the reactor tube walls. The fouling, or buildup of insoluble coke particles on the tube walls, is cleaned at regular maintenance intervals leading to scheduled shutdowns to replace and clean the reactor tubes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In an embodiment of the subject disclosure, an apparatus and method is provided to heat hydrocarbon fluid (such as heavy crude oil) by electromagnetic radiation confined within a traveling wave structure. Electromagnetic (EM) radiation is generated by an EM source (at radio frequency (RF) or microwave (MW) frequencies) and delivered to the traveling wave structure by a transmission line and coupler.

The hydrocarbon fluid can flow at a controlled flow rate through the traveling wave structure while being heated by the EM radiation propagating within the traveling wave structure. Alternatively, the hydrocarbon fluid can remain stationary inside the traveling wave structure while being heated by the EM radiation propagating within the traveling wave structure.

The hydrocarbon fluid heated by the apparatus can be crude oil, heavy oil, or bitumen.

In one embodiment, the traveling wave structure can be a sealed vessel that defines an internal chamber that contains the hydrocarbon fluid and that supports the propagation of the EM radiation within the internal chamber. The coupler can be disposed at a first end of the traveling wave structure opposite a second end. The coupler operably couples the EM radiation source to the traveling wave structure. The coupling strength of the coupler can be tuned such that the effective load impedance matches the output impedance of the EM radiation source in order to maximize power transfer. The hydrocarbon fluid can be loaded into the second end of the traveling wave structure opposite the coupler. An electromagnetic transparent wall (or disk) can be disposed adjacent the coupler at the first end of the traveling wave structure. The electromagnetic transparent wall (or disk) operates to prevent the hydrocarbon fluid contained in the internal chamber of the traveling wave structure from flowing into the transmission line while further operating to allow the EM radiation delivered by the transmission line to pass through the wall (or disk) and into the traveling wave structure. A hydrocarbon fluid source can load hydrocarbon fluid into the internal chamber of the traveling wave structure via an inlet at or near the second end of the traveling wave structure opposite the coupler. A high pressure seal can be used to prevent fluid leakage at the inlet of the traveling wave structure.

The transmission line and/or the traveling wave structure can be a waveguide or a coaxial transmission line. The waveguide is a tubular, rectangular, or conceivably any shaped body primarily made with conducting material that supports the desired propagation of EM radiation. The coaxial transmission line is a waveguide containing one or more coaxial structure(s) in tubular, rectangular, or conceivably any shape, commonly known as the inner conductor, primarily made with conducting material. Thermal insulation can cover the outside diameter of the traveling wave structure.

The hydrocarbon fluid contained in the internal chamber of the traveling wave structure is heated by the EM radiation that propagates in the internal chamber of the traveling wave structure. The hydrocarbon fluid can be heated to a desired reaction temperature suitable for visbreaking of the hydrocarbon fluid at a location near the first end of the traveling wave structure adjacent the coupler. The traveling wave structure can include a number of through-holes or other structures that are disposed near this location at the first end of the traveling wave structure and surrounded by a collecting cell. The hydrocarbon fluid that is heated to the desired reaction temperature can exit the traveling wave structure through the through-holes into the collecting cell. Furthermore, the through-holes can be configured as a Faraday cage that limits the leakage of EM radiation through the through-holes. In one embodiment, the size of the openings of the through-holes can be less than a quarter of the wavelength of the EM radiation propagating in this traveling waveguide structure.

In one embodiment, the reaction temperature is in the range of 350° C. to 500° C., which is suitable for permanent visbreaking of heavy crude oil feedstock (i.e., the thermal cracking of the heavy crude oil feedstock with relatively low conversion of the residual fraction such that the viscosity of the oil is reduced without significantly altering the quality of the oil). The apparatus and methodology of visbreaking can be used to irreversibly reduce the viscosity of a variety of hydrocarbon fluids, such as heavy crude oil, other viscous crude oils, and bitumen.

A soaker section can be fluidly coupled to the internal chamber of the traveling wave structure. In one embodiment, the soaker section can extend from the collecting cell. The soaker section operates to maintain the temperature of the heated hydrocarbon fluid that flows from the traveling wave structure in the desired reaction temperature range for a period of time. The soaker section can include a length of pipe along with insulation and/or heating along such length of pipe such that the temperature of the hydrocarbon fluid disposed in the length of pipe is maintained in the desired reaction temperature range over such length of pipe. The soaker section can include one or more layers of thermally-insulative material (such as mineral fiber, glass fiber, silica, aerogel, or other suitable insulating material) that surrounds the length of pipe. Such thermally-insulative material insulates the length of pipe to minimize conductive heat loss from the hydrocarbon fluid disposed in the length of pipe. The soaker section can also include resistive heat tape or a heater coil wrapped around the length of pipe under the thermally-insulative material. The resistive heat tape or heater coil can be configured to apply heat to the length of pipe and to the hydrocarbon fluid disposed therein as desired. The soaker section can also include a pressure vessel that contains the hydrocarbon fluid with thermally-insulative material that surrounds the pressure vessel. The soaker section can also include an active heater element (such as a heating coil) that is disposed between the thermally-insulative material and the vessel wall.

A temperature sensor can be located inside the traveling wave structure in direct contact with the hydrocarbon fluid. The temperature sensor can extend outside the traveling wave structure to associated processing equipment for deriving the temperature of the hydrocarbon fluid at one or more positions inside the traveling wave structure during the hydrocarbon fluid heating (e.g., visbreaking) process.

Pumps and valves can be integrated into the flow path of the hydrocarbon fluid and configured to supply pressurized hydrocarbon fluid into the internal chamber of the traveling wave structure (and possibly the collecting cell and parts or all of the soaker section) during the visbreaking process such that the hydrocarbon fluid remains in a liquid phase so as to suppress the gas phase and avoid two phase flow in such structures. This provides better control by minimizing the variability in the residence time and temperature profiles experienced by the hydrocarbon fluid during the visbreaking process, which in turn provides improved control of the targeted visbreaking reactions. In one embodiment, the hydrocarbon fluid is pressurized up to 5000 psi (351.5 kg/square cm) during the visbreaking process such that it remains in a liquid phase so as to suppress the gas phase and avoid two phase flow in the traveling wave structure. The pumps and valves can be configured such that the pressurized hydrocarbon fluid is stationary during the visbreaking process. Alternatively, the pumps and valves can be configured such that the pressurized hydrocarbon fluid flows continuously through the traveling wave structure (and possibly the collecting cell and parts or all of the soaker section) during the visbreaking process.

The traveling wave structure can be configured to support or facilitate propagation of at least one mode of electromagnetic radiation within the microwave radio frequency band—the frequency band between 0.1 GHz and 100 GHz. The traveling wave structure can be designed to operate at one or more predefined frequency(ies) within the microwave radio frequency band depending on the specific flow rate requirements. The geometry of the traveling wave structure can be optimized to ensure that the vast majority of the EM radiation is delivered to the traveling wave structure. The material of the traveling wave structure, the power transmission line, and the coupler can be optimized to minimize energy loss and thereby allow the maximum amount of energy dissipation to heat the hydrocarbon fluid while avoiding thermally-driven coke buildup on the inside walls of the traveling wave structure.

In one embodiment, the traveling wave structure supports or facilitates propagation of a single TM₀₁ mode traveling wave for heating the hydrocarbon fluid inside the traveling wave structure. The traveling wave structure can also support or facilitate propagation of additional single TM and TE modes of EM waves, if desired. Additional undesired modes can be suppressed through mechanical means or electrical means or avoided by a precise frequency tracking technique.

The desired temperature profile of the hydrocarbon fluid in the traveling wave structure can be a monotonic increasing profile whose peak is at the desired reaction temperature and is located near the exit of the traveling wave structure. Such a monotonic increasing profile can minimize oscillations in the temperature profile of the hydrocarbon fluid over time in the case of flowing fluid.

In order to maximize energy efficiency, the reflected power at the coupler can be minimized. This can be achieved by impedance matching such that the impedance of the transmission line matches the impedance of the traveling wave structure.

In another aspect, an apparatus for heating a hydrocarbon fluid with EM radiation includes a plurality of traveling wave structures (heater sections) as described above. The plurality of heater sections are configured such that the traveling wave structures contain hydrocarbon fluid that is subject to heating by the EM radiation propagating within such traveling wave structures in a parallel manner. The frequency(ies) supported by such traveling wave structures can lie in a frequency band between 0.1 GHz and 100 GHz. Multiple EM sources can supply microwave radiation to corresponding traveling wave structures of the heater sections. An EM source can cooperate with a power splitter to split microwave radiation into multiple legs for supply to a number of the traveling wave structures for the heater sections. A flow splitter and associated tubing can distribute an inflow of hydrocarbon fluid to traveling wave structures of the heater sections.

Soaker sections (including at least one soaker vessel) can be disposed downstream of the plurality of heater sections. The soaker sections can be configured to contain hydrocarbon fluid and limit heat loss from the contained hydrocarbon fluid. The soaker sections can include an active heater element (such as heat tape or a heating coil).

Further features and advantages of the subject application will become more readily apparent from the following detailed description when taken in conjunction with the accompanying drawings.

### BRIEF DESCRIPTION OF THE DRAWINGS

The present application is further described in the detailed description which follows, and in reference to the noted plurality of drawings by way of non-limiting examples of embodiments of the present application, in which like reference numerals represent like elements throughout the several views of the drawings. The application file contains at least one drawing executed in color. Copies of this patent application publication with color drawing(s) will be provided by the Office upon request and payment of the necessary fee.

FIGS. 1 and 2 are schematic cross-sectional views of an illustrative embodiment of an apparatus for heating hydrocarbon fluid employing EM radiation that propagates within a traveling wave structure.

FIG. 3 is a schematic cross-sectional view through the coupler end of the traveling wave structure and the collecting cell and the soaker section of the apparatus of FIGS. 1 and 2.

FIG. 4 is a diagram illustrating the amplitude of the electric field distribution in the traveling wave structure of FIGS. 1-3 during an illustrative visbreaking process with the presence of hydrocarbon fluids.

FIG. 5 is a diagram illustrating the power loss density distribution in the traveling wave structure of FIGS. 1-3 during the illustrative visbreaking process with the presence of hydrocarbon fluids.

FIG. 6 illustrates curves that show the impedances of the traveling wave structure and transmission line of FIGS. 1-3 as a function of the frequency of EM radiation propagating in the structure.

FIG. 7 is a plot of the reflection coefficient (S₁₁ of the S-parameters) of the traveling wave structure of FIGS. 1-3 over a frequency range with the impedance at the EM power source set to 210Ω, which demonstrates the cutoff frequency of 2.7 GHz and matched-impedance coupling at around 3.25 GHz as derived from analytical calculations in FIG. 6.

FIGS. 8A and 8B are top and front views, respectively, of an illustrative embodiment of an apparatus for heating hydrocarbon fluid employing microwave radiation; the apparatus employs four microwave heater sections and one soaker vessel.

FIGS. 9A and 9B are top and front views, respectively, of an illustrative embodiment of an apparatus for heating hydrocarbon fluid employing microwave radiation; the apparatus employs four microwave heater sections and two soaker vessels.

### DETAILED DESCRIPTION

The particulars shown herein are by way of example and for purposes of illustrative discussion of the embodiments of the present application only and are presented in the cause of providing what is believed to be the most useful and readily understood description of the principles and conceptual aspects of the present application. In this regard, no attempt is made to show structural details in more detail than is necessary for the fundamental understanding of the present application, the description taken with the drawings making apparent to those skilled in the art how the several forms of the present application may be embodied in practice.

In the present application, the term electromagnetic (EM) radiation or energy or microwave radiation or energy or radio frequency (RF) radiation or energy refer to electromagnetic waves within the microwave radio-frequency band.

The term “traveling wave electromagnetic radiation” or “traveling wave EM radiation” is EM radiation that has crests and troughs that constantly move from one point to another as the crests and troughs propagate over a length or distance. In this way, the EM radiation is transmitted along the direction of propagation of the traveling wave EM radiation. Traveling wave EM radiation is different from “standing wave EM radiation” that has crests and troughs that have fixed positions in space.

The term “traveling wave structure” is a structure that supports or facilities the propagation of traveling wave EM radiation.

The term “dBm” is a power value in decibels (dB) referenced to one milliwatt of power.

The term “incident power” refers to the EM radiation power (such as in dB or dBm or watts) being supplied to a traveling wave structure, which may or may not include both amplitude and phase information.

The term “reflected power” refers to the EM radiation power (such as in dB or dBm or watts) that is reflected from a traveling wave structure, which may or may not include both amplitude and phase information.

The term “absorbed power” refers to the EM radiation power (such as in dB or dBm or watts) that is absorbed by a traveling wave structure and the hydrocarbon fluids contained therein, which may or may not include both amplitude and phase information.

The term “transmitted power” refers to the EM radiation power (such as in dB or dBm or watts) that is transmitted through a traveling wave structure, which may or may not include both amplitude and phase information.

The term “power loss density distribution” refers to the spatial distribution of the power of the EM radiation absorbed within a traveling wave structure.

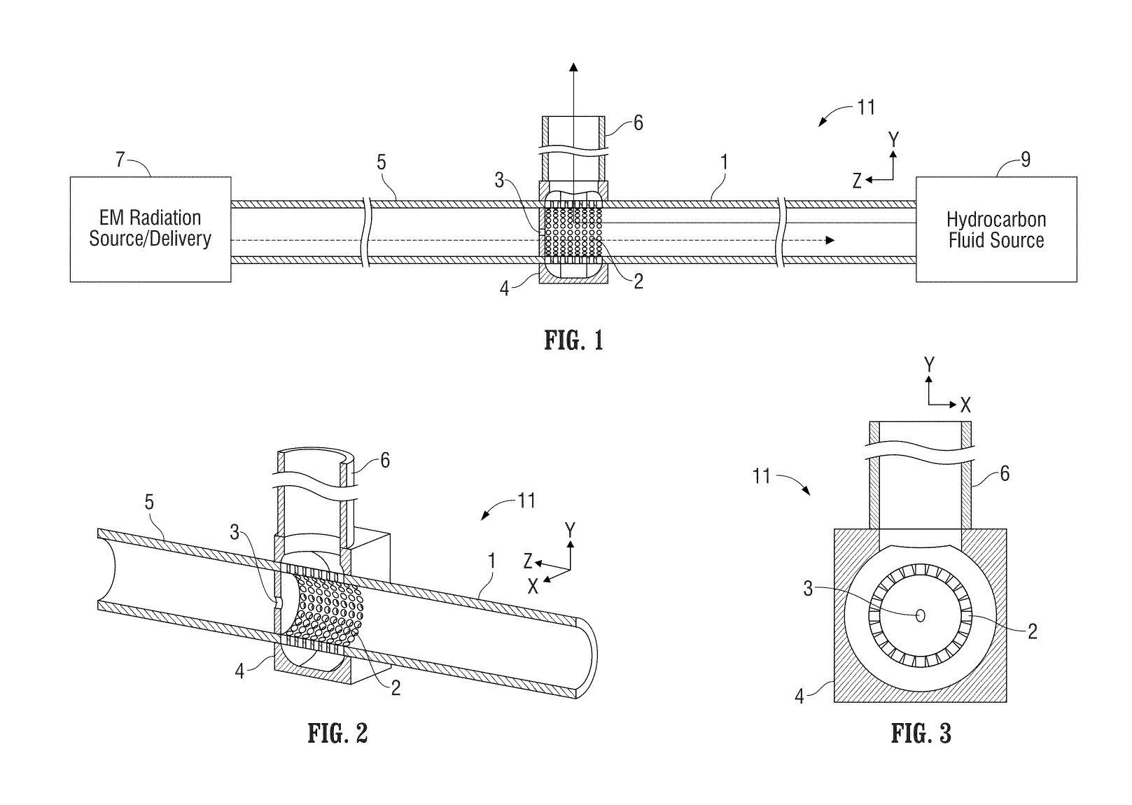

FIGS. 1, 2, and 3 illustrate an embodiment of an apparatus 11 (and corresponding method of operation) for microwave heating of hydrocarbon fluid (such as heavy crude oil) by traveling wave EM radiation propagating within a traveling wave structure 1. An EM radiation source and delivery system 7 generates EM radiation (at radio frequency (RF) or microwave (MW) frequencies) and delivers such EM radiation to a transmission line 5, which supplies such EM radiation to the traveling wave structure 1 by a coupler 3 to produce the traveling wave EM radiation that propagates within the traveling wave structure 1. The traveling wave structure 1 is a sealed vessel defining an internal chamber that is configured to contain the hydrocarbon fluid and support the propagation of traveling wave EM radiation within its internal chamber. The traveling wave structure 1 can be made of a metallic material (such as aluminum, stainless steel, copper, bronze, or any electrically conductive metal) that is primarily reflective of EM radiation with minimal absorption. The coupler 3 is disposed at a first end of the traveling wave structure 1 opposite a second end. The coupler 3 provides coupling of EM radiation from the transmission line 5 to the traveling wave structure 1. The coupling strength of the coupler 3 can be tuned such that the effective load impedance matches the output impedance of the transmission line 5 in order to maximize power transfer.

The transmission line 5 and/or the traveling wave structure 1 can be a waveguide or a coaxial transmission line. The waveguide is a tubular, rectangular, or conceivably any shaped body primarily made with conducting material that supports the desired propagation of EM radiation. The coaxial transmission line is a waveguide containing one or more coaxial structure(s) in tubular, rectangular, or conceivably any shape, commonly known as the inner conductor, primarily made with conducting material. Thermal insulation can cover the outside diameter of the traveling wave structure 1.

A hydrocarbon fluid source 9 can load hydrocarbon fluid into the internal chamber of the traveling wave structure 1 via an inlet at or near the second end of the traveling wave structure 1 opposite the coupler 3 as shown in FIG. 1. A high pressure seal can be used to prevent fluid leakage at the inlet of the traveling wave structure 1.

The coupler 3 can be an iris-type coupler as is well known. The iris-type coupler provides coupling of EM radiation from the transmission line 5 to the traveling wave structure 1. The coupling strength of the iris-type coupler can be tuned such that the effective load impedance matches the output impedance of the transmission line 5 in order to maximize power transfer. The coupler 3 can include a wall (or disk) made from a material primarily transparent to the electromagnetic radiation, such as sapphire, quartz, or alumina. The wall (or disk) can operate to prevent the hydrocarbon fluid contained in the internal chamber of the traveling wave structure 1 from flowing into the transmission line 5 while further operating to allow the electromagnetic radiation delivered by the transmission line 5 to pass through the coupler 3 into the traveling wave structure 1 with minimal loss. It is also contemplated that other EM power coupling schemes can be used to introduce traveling wave EM radiation into the traveling wave structure. There are various known options available for such coupling designs. Other options include, but are not limited to, a combination of coaxial(s) and loop(s), or a combination of coaxial(s) and antenna(s), or a combination of different schemes.

The hydrocarbon fluid contained in the internal chamber of the traveling wave structure 1 is heated by the traveling wave electromagnetic radiation that propagates in the internal chamber of the traveling wave structure 1. The hydrocarbon fluid can be heated to a desired reaction temperature suitable for visbreaking of the hydrocarbon fluid at a location near the first end (adjacent the coupler 3) of the traveling wave structure 1. The traveling wave structure 1 can include a number of through-holes 2 or other structures that are disposed near this location at the first end of the traveling wave structure 1 and surrounded by a collecting cell 4. The hydrocarbon fluid that is heated to the desired reaction temperature can exit the traveling wave structure 1 through the through-holes 2 into the collecting cell 4. The through-holes 2 can cover the entire circumference of the first end (adjacent the coupler 3) of the traveling wave structure 1 to allow for collection of hydrocarbon fluid from the traveling wave structure 1 from all angles in order to minimize localized heating and thus coking.

In one embodiment, the reaction temperature is in the range of 350° C. to 500° C., which is suitable for permanent visbreaking of heavy crude oil feedstock (i.e., the thermal cracking of the heavy crude oil feedstock with relatively low conversion of the residual fraction such that viscosity of the oil is reduced without significantly altering the quality of the oil). Furthermore, the through-holes 2 can be configured as a Faraday cage that limits the leakage of EM radiation through the through-holes 2. In one embodiment, the size of the openings of the thru-holes 2 can be less than a quarter of the wavelength of the EM radiation propagating in this traveling waveguide structure 1. The apparatus and methodology of visbreaking can be used to irreversibly reduce the viscosity of a variety of hydrocarbon fluids, such as heavy crude oil, other viscous crude oil, and bitumen.

A soaker section 6 can extend from the collecting cell 4. The soaker section 6 operates to maintain the temperature of the heated hydrocarbon fluid that flows from the traveling wave structure 1 at the desired reaction temperature range for a period of time. The soaker section 6 can include a length of pipe along with insulation and/or heating along such length of pipe such that the temperature of the hydrocarbon fluid disposed in the length of pipe is maintained in the desired reaction temperature range over such length of pipe. The soaker section 6 can include one or more layers of thermally-insulative material (such as mineral fiber, glass fiber, silica, aerogel, or other suitable insulating material) that surrounds the length of pipe. Such thermally-insulative material insulates the length of pipe to minimize conductive heat loss from the hydrocarbon fluid disposed in the length of pipe. The soaker section 6 can also include resistive heat tape or a heater coil wrapped around the length of pipe under the thermally-insulative material. The resistive heat tape or heater coil can be configured to apply heat to the length of pipe and to the hydrocarbon fluid disposed therein as desired. The soaker section 6 can also include a pressure vessel that contains the hydrocarbon fluid with thermally-insulative material that surrounds the pressure vessel. The soaker section 6 can also include an active heater element (such as a heating coil) that is disposed between the thermally-insulative material and the pressure vessel.

A temperature sensor, which can be made from a material that is primarily transparent to microwave radiation, such as a single-crystal sapphire optical fiber temperature sensor, can be located inside the traveling wave structure 1 in direct contact with the hydrocarbon fluid. The temperature sensor can extend outside the traveling wave structure 1 to associated processing equipment for deriving temperature of the hydrocarbon fluid at one more positions inside the traveling wave structure 1 during the visbreaking process.

Pumps and valves can integrated into the flow path of the hydrocarbon fluid and configured to supply pressurized hydrocarbon fluid into the internal chamber of the traveling wave structure 1, the collecting cell 4, and possibly parts or all of the soaker section 6 during the visbreaking process such that it remains in a liquid phase so as to suppress the gas phase and avoid two phase flow in such structures. This provides better control by minimizing the variability in the residence time and temperature profiles experienced by the hydrocarbon fluid during the visbreaking process, which in turn provides improved control of the targeted visbreaking reactions. In one embodiment, the hydrocarbon fluid is pressurized up to 5000 psi (351.5 kg/square cm) inside the traveling wave structure 1, the collecting cell 4 and possibly parts or all of the soaker section 6 during the visbreaking process such that it remains in a liquid phase so as to suppress the gas phase and avoid two phase flow in the traveling wave structure. The pumps and valves can be configured such that the pressurized hydrocarbon fluid is stationary inside the traveling wave structure 1, the collecting cell 4, and possibly parts or all of the soaker section 6 during the visbreaking process. Alternatively, the pumps and valves can be configured such that the pressurized hydrocarbon fluid flows continuously through the traveling wave structure 1, the collecting cell 4, and possibly parts or all of the soaker section 6 during the visbreaking process.

The traveling wave structure 1 can be configured to support or facilitate propagation of at least one mode of electromagnetic radiation within the microwave radio frequency band—the frequency band between 0.1 GHz and 100 GHz. As used herein, the term “mode” refers to a particular pattern of an electromagnetic wave that satisfies Maxwell's equations and the applicable boundary conditions of the traveling wave structure. In the traveling wave structure 1, the mode can be any one of the various possible patterns of electromagnetic waves. Each mode is characterized by its frequency and wave pattern. The electromagnetic wave pattern of a mode depends on the frequency, refractive indices, or dielectric constants of the materials of the traveling wave structure 1 and the hydrocarbon fluid, and the geometry of the traveling wave structure 1. Note that a transverse electric (TE) mode is one whose electric field vector is normal to a particular plane of reference. Similarly, a transverse magnetic (TM) mode is one whose magnetic field vector is normal to a particular plane of reference. Each of the modes can be identified with one or more subscripts (e.g., TE₀₁). Each subscript attributes to the boundary condition in Maxwell's equations for a particular dimension in the polar coordinate system.

The traveling wave structure 1 can be designed to operate at one or more predefined frequency(ies) within the microwave radio frequency band depending on the specific flow rate requirements. The geometry of the traveling wave structure 1 can be optimized to ensure that the vast majority of the EM radiation is delivered to the traveling wave structure 1. The material of the traveling wave structure 1, the power transmission line 5 and the coupler 3 can be optimized to minimize energy loss and thereby allow the maximum amount of energy dissipation to heat the hydrocarbon fluid while avoiding thermally-driven coke buildup on the inside walls of the traveling wave structure 1. In one embodiment, the traveling wave structure 1 supports or facilitates propagation of a single TM₀₁ mode traveling wave for heating the hydrocarbon fluid inside the traveling wave structure 1. The traveling wave structure 1 can also support or facilitate propagation of additional single TM and TE modes of traveling and/or standing waves, if desired. Additional undesired modes can be suppressed through mechanical means or electrical means or avoided by a precise frequency tracking technique.

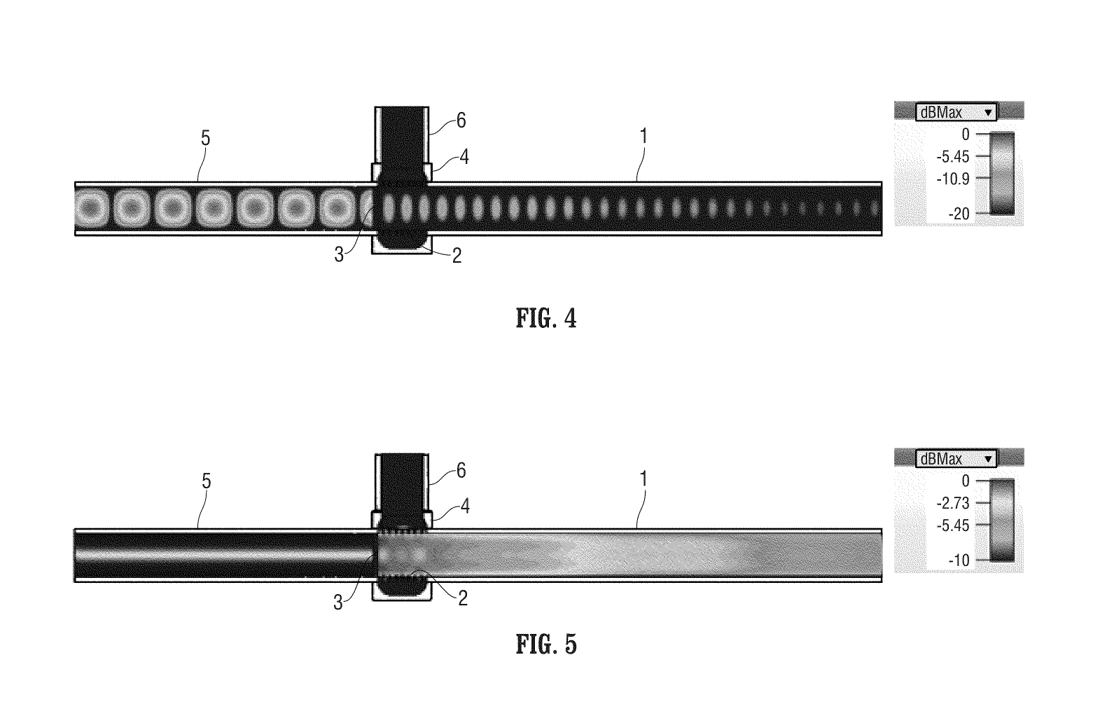

FIGS. 4 and 5 show simulation results where the illustrative traveling wave structure of FIGS. 1-3 is used to heat a stationary hydrocarbon fluid, such as heavy oil. FIG. 4 shows the amplitude of the axial component (z-component) of the electric field distribution of the TM₀₁ mode traveling EM radiation propagating through the traveling wave structure 1. FIG. 5 shows the power loss density distribution for the TM₀₁ mode traveling EM radiation propagating through the traveling wave structure 1 at a frequency near 1.9 GHz. The predicted results are desirable in the sense that the majority of the EM radiation is dissipated on the hydrocarbon fluid contained inside traveling wave structure 1 and thus provides efficient heating of such fluid. Note that the EM fields are confined in the traveling wave structure 1 and are shielded from entering the collecting cell 4 and the soaker section 6 by the Faraday cage design of the through-holes 2. Per well-known microwave engineering practice, the size of the openings of the through-holes 2 can be less than a quarter of the propagation wavelength, which, in this example, is approximately 12 mm. In one embodiment, the microwave power leaking out from the Faraday cage design of the through-holes 2 is less than 1 percent even for an opening size of 15 mm.

The visbreaking process can be performed as a continuous process by flowing the hydrocarbon fluid through the traveling wave structure 1 while the traveling wave EM radiation propagates inside the traveling wave structure 1. The hydrocarbon fluid enters the traveling wave structure 1 where its temperature is raised to the desired reaction temperature by microwave heating. It then exits through the through-holes 2 into the collector cell 4 and flows into the soaker section 6, which maintains the flowing fluid within the desired range of reaction temperature throughout the length of the soaker section. In the example shown in FIGS. 1-3, the hydrocarbon fluid flow is from right to left inside the traveling wave structure 1 as noted by the solid-line arrow, while the traveling wave EM radiation propagates from the left to right inside the traveling wave structure 1 as noted by the dashed-line arrow. As indicated by FIG. 5, as the hydrocarbon liquid flows into the traveling wave structure 1, it is exposed to a rapidly increasing EM power intensity which leads to rapid and efficient heating. The hydrocarbon fluid is at the desired reaction temperature when exiting the traveling wave structure 1 through the through-holes 2 into the collector cell 4 and then flowing into the soaker section 6. The soaker section 6 can be optimized to provide insulation or/and heating to ensure the reaction temperature is maintained within the desired operating temperature range for a desired residence time.

The desired temperature profile of the hydrocarbon fluid in the traveling wave structure 1 can be a monotonically increasing profile whose peak is at the desired reaction temperature and is located near the exit defined by the through-holes 2 of the traveling wave structure 1. Such a monotonically increasing profile can minimize oscillations in the temperature profile of the hydrocarbon fluid over time in the case of flowing fluid.

In order to maximize energy efficiency, the reflected power at the coupler 3 (which is at the transition between the transmission line 5 and the traveling wave structure 1) can be minimized. This can be achieved by impedance matching such that the impedance of the transmission line 5 matches the impedance of the traveling wave structure 1. For the case where the transmission line 5 and the traveling wave structure 1 are cylindrical waveguides, the impedance of the respective cylindrical waveguide, Z, can be determined by

$$\begin{matrix}Z ( R , {ɛ}_{r} , f ) = \frac{{Z}_{0}}{\sqrt{{ɛ}_{r}}} \sqrt{1 - {( \frac{{f}_{c}}{f} )}^{2}} \\ where & ( 1 ) \\ {f}_{c} ( R , {ɛ}_{r} ) = \frac{c / \sqrt{{ɛ}_{r}}}{{λ}_{c}} = \frac{c / \sqrt{{ɛ}_{r}}}{2 π R / 2.405} . & ( 2 )\end{matrix}$$

The parameter f_{c} is the cutoff frequency for TM₀₁ mode in a cylindrical waveguide in this example. The parameter Z₀ is the free space impedance of 377Ω. The parameter c is the speed of light. The parameter f is the EM wave propagation frequency. The parameter ∈ᵣ is the relative permittivity of the material filling the transmission line 5 or the traveling wave structure 1 uniformly. The parameter R is the radius of the waveguide for transmission line 5 or the traveling wave structure 1, respectively.

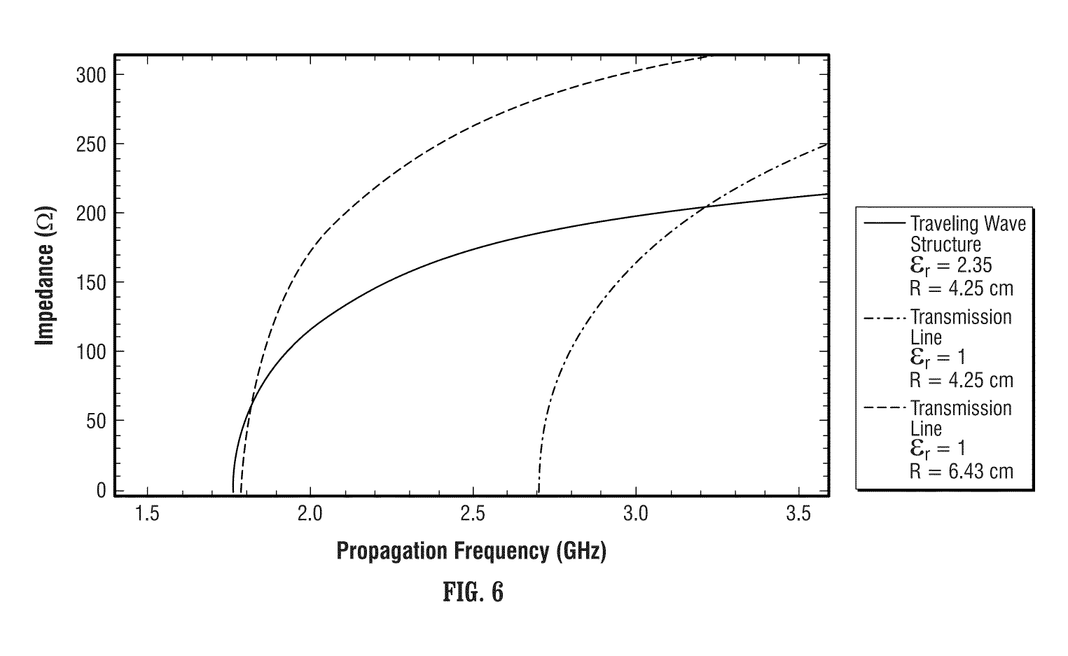

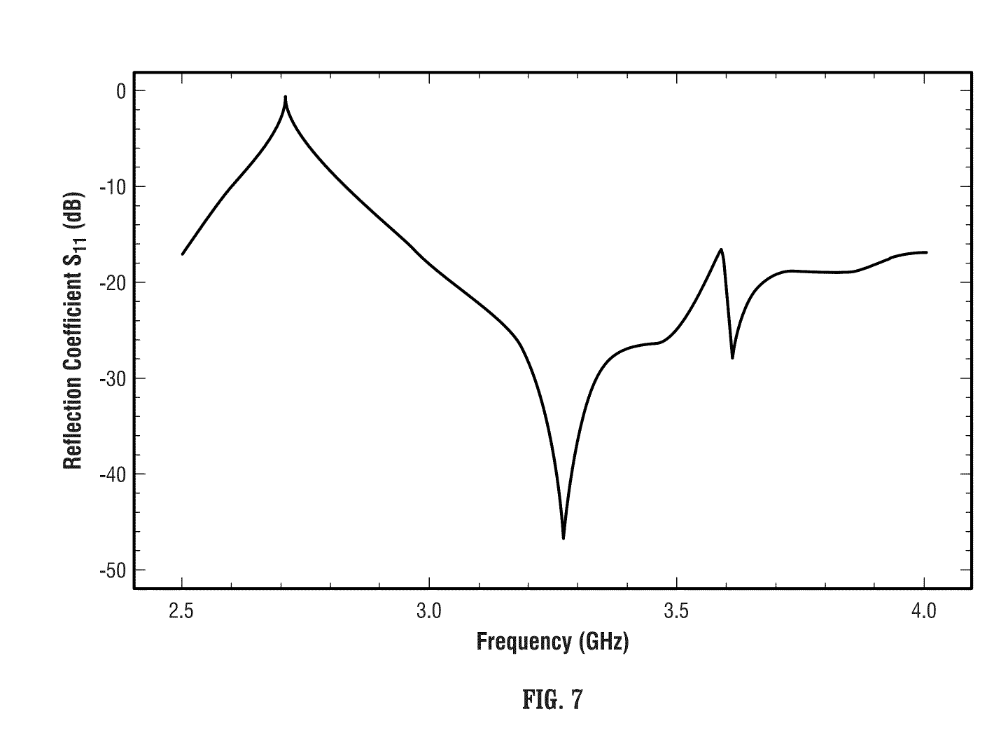

There are various ways to perform impedance matching. Two possible ways are demonstrated in the following. Using ∈ᵣ=2.35 (hydrocarbon fluid) and R=4.25 cm for the traveling wave structure 1, and ∈ᵣ=1 (air) and R=4.25 cm or 6.43 cm for the transmission line 5, the impedances are plotted in FIG. 6. One way to match the impedance is to increase the radius of the transmission line 5 to about 6.47 cm and configure the power source to output at around 1.8 GHz and a commonly used source impedance of about 50Ω. Another way is to keep the size of the transmission line 5 and the traveling wave structure 1 the same and configure the microwave power source to output at around 3.25 GHz and a source impedance of about 210Ω. Modeling that demonstrates the latter case is shown in FIG. 7, which shows the reflected power response, S11 of the scattering parameters, when the impedance at the microwave power source is set to 210Ω. The modeling result demonstrates the cutoff frequency of 2.7 GHz and optimal coupling at around 3.25 GHz derived from analytical calculations.

Per well-known microwave engineering principles, temperature control mechanisms can be used to maintain the optimal EM mode and the desired heating efficiency, as well as the desired fluid temperature within the traveling wave structure 1. Such temperature control mechanisms can include one or more temperature sensor(s) that measure the temperature of the hydrocarbon fluid heated within the traveling wave structure 1 at one or more spatial locations within the traveling wave structure 1 over time. Such temperature measurements can be used to control the incident power of the EM radiation delivered to the traveling wave structure 1 in order to achieve the desired temperature profile. Impedance matching control can be achieved by i) frequency tracking where the frequency of the EM radiation supplied by the EM radiation source and delivery system 7 is updated and/or ii) the impedance of the transmission line 5 and/or the traveling wave structure 1 are/is updated by tuning mechanisms to control the volume of these sections, including, but not limited to, mechanical and thermal measures. An example is the use of one or more stub/plunger tuners in the transmission line 5 and/or the traveling wave structure 1. Another example is the use of one or more movable walls for the transmission line 5 and/or the traveling wave structure 1. Both of these mechanisms enable control of the volume of such structures and thus the impedances of such structures. The plunger(s) and/or the movable wall(s) can include an electrically-controlled actuator that controls the linear movement of such mechanisms for mechanical frequency tuning. Other electrically-controlled actuators can be used for mechanical frequency tuning. The electrically-controlled actuator can be electrically coupled to a control system for real time frequency control. Impedance matching control can also employ monitoring and assurance of the minimization of the reflected power (which can be indicated by S₁₁ of the scattering parameters), or equivalently of the maximization of the injected power, and maintenance of the desired TM or TE mode(s).

Per well-known reactor engineering principles, the amount of conversion (i.e. visbreaking) will be dictated by the amount of time the hydrocarbon fluid remains at the desired reaction temperature, also known as the residence time. The desired flow rate and the volume (which can be dictated by the diameter and length) of the traveling wave structure 1 can be used to determine the residence time.

In one aspect, larger flow rates can be accommodated while maintaining the desired reaction temperature and residence time to allow 5-40 percent conversion of the residual portion of the oil where the residual portion is defined as the fraction of oil that distills above 524° C. or above. The scaling of the design to accommodate a range of larger flow rates may be achieved by using a combination of:
i) increasing the diameter of the traveling wave structure 1;
ii) adding additional traveling wave structures 1;
iii) increasing the dimensions (e.g. length and diameter of a cylinder) of the soaker section 6; and
iv) increasing the number of soaker sections 6.

Note that increasing the diameter of the traveling wave structure 1 in general implies a drop in its cutoff frequency and thus an increase in its impedance. The microwave delivery system, coupling, and impedance matching follow the descriptions above.

Table 1 is a summary of illustrative calculations illustrating how scaling of the traveling wave structure 1 of the apparatus of FIGS. 1-3 can be achieved.

TABLE 1

| Mode | | TM₀₁ | | |
|---|---|---|---|---|
| Residence Time | | t* = 30 | | |
| (seconds) | | | | |
| Temperature Increase | | ΔT = 100° C. | | |
| (° C.) | | | | |
| Free-space | Oil | Traveling Wave | | Traveling Wave |
| Cutoff | Cutoff | Structure | Flow Rate | Structure |
| Frequency | Frequency | Diameter | (barrels/ | Length |
| (GHz) | (GHz) | (cm) | day) | (cm) |
| 23.0 | 15.0 | 1 | 0.26 | 18.4 |
| 7.78 | 5.08 | 2.95 | 5.6 | 45.3 |
| 6.12 | 3.99 | 3.75 | 12.1 | 60.7 |
| 4.59 | 2.99 | 5 | 31.6 | 89 |
| 2.70 | 1.76 | 8.5 | 150 | 146 |

where:

“Residence Time”, in seconds is the total time the hydrocarbon fluid is heated inside the traveling wave structure 1 to provide the Temperature Increase to the desired reaction temperature;

“Temperature Increase” is the temperature increase (in °C.) from the temperature of the hydrocarbon fluid at the inlet of the traveling wave structure 1 to the desired reaction temperature;

“Free-space Cutoff Frequency” is the cutoff frequency (in GHz) of the EM radiation supplied to the transmission line 5;

“Oil Cutoff Frequency” is the cutoff frequency (in GHz) of the TM₀₁ mode EM radiation propagating in the traveling wave structure;

“Traveling Wave Structure Diameter” is the inside diameter (in cm) of the traveling wave structure 1 that contains the hydrocarbon fluid; and

“Traveling Wave Structure Length” is the length (in cm) of the traveling wave structure 1 that is required to heat the hydrocarbon fluid oil to the desired reaction temperature.

In Table 1, it is assumed that a Residence Time of 30 seconds is required for the case where the traveling wave EM radiation in the traveling wave structure 1 heats the hydrocarbon fluid from an initial temperature below the 350-500° C. range of the reaction temperature to a desired reaction temperature within the 350-500° C. for the visbreaking process. In this manner, the microwave radiation heats the hydrocarbon fluid to raise its temperature by 100° C. In order to provide the hydrocarbon fluid at the initial temperature (100° C. less than the desired reaction temperature), the hydrocarbon fluid can be preheated. Such preheating reduces the amount of EM radiation that is required to heat the hydrocarbon fluid to the desired reaction temperature for thermal visbreaking. Such preheating can be carried out through conventional means, such as electric, gas fired, coal burning, or other suitable fluid heating schemes. Table 1 allows one to determine the dimensions of the traveling wave structure 1 and the flow rate that can be achieved for each operating frequency.

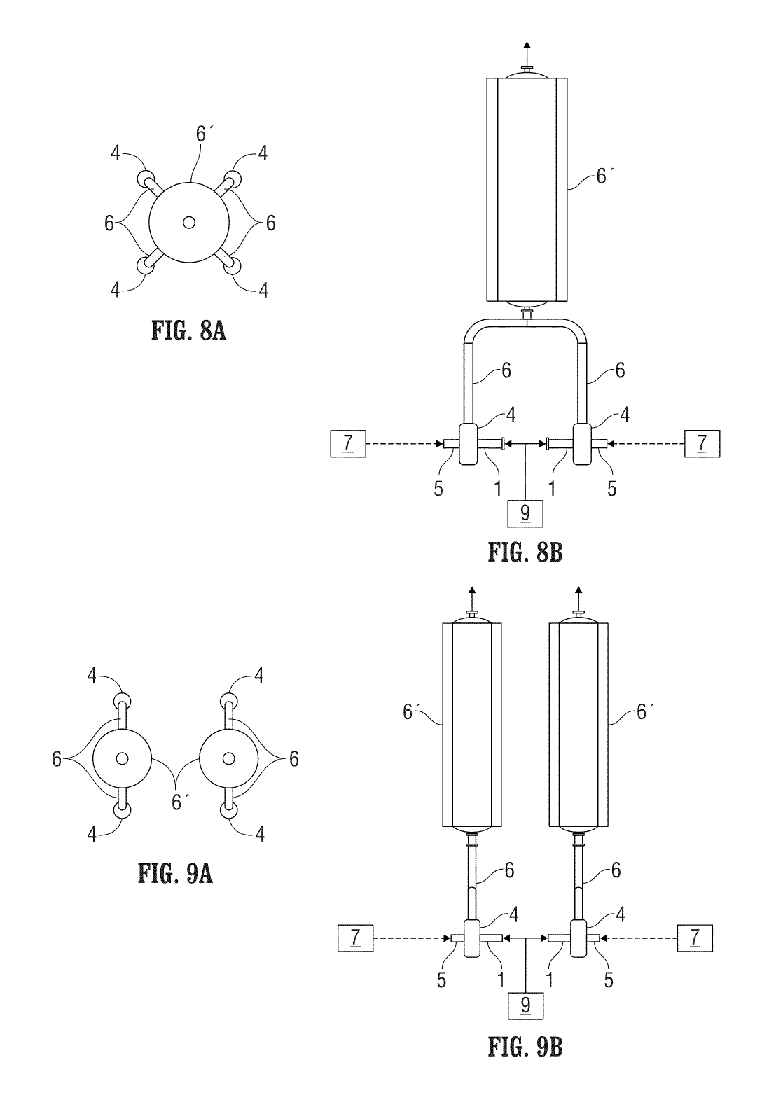

As mentioned above, scaling (to achieve higher flow rates) can also be performed by using different combinations of the microwave traveling wave structure 1 and soaker sections 6. In all cases, the flow of the hydrocarbon fluid is into the traveling wave structure section(s) 1 followed by the soaker section(s) 6. The number of traveling wave structures 1 is dictated by the hydrocarbon liquid flow rate and the flow rate capacity of each traveling wave structure 1 for the given volume of the structure and required residence time. The number and configuration of the soaker sections 6 can depend on the volume requirement, required residence time, and operational restrictions, such as physical space, pressure handling capabilities, and flow restrictions. For demonstration purposes, two possible examples of how to handle larger flow rates are shown in FIGS. 8A and 8B and FIGS. 9A and 9B.

FIGS. 8A and 8B show an apparatus for heating a hydrocarbon fluid with traveling wave EM radiation that includes four traveling wave structures (heater sections) 1 as described above. The four heater sections are configured such that the traveling wave structures 1 contain hydrocarbon fluid that is subject to heating by the traveling wave EM radiation propagating within such traveling wave structures 1 in a parallel manner. The frequency(ies) supported by such traveling wave structures 1 can lie in a frequency band between 0.1 GHz and 100 GHz. Multiple EM sources can supply microwave radiation to corresponding traveling wave structures of the heater sections 1. An EM source can cooperate with a power splitter to split microwave radiation into multiple legs for supply to a number of the traveling wave structures 1 for the heater sections. A flow splitter and associated tubing can distribute an inflow of hydrocarbon fluid 9 to traveling wave structures of the heater sections.

The output of the four traveling wave structures 1 flows through four corresponding soaker sections 6 and then the flow is combined into a single soaker vessel 6′, where the heated hydrocarbon fluid is allowed to remain for the desired average residence time. The soaker sections 6 and the soaker vessel 6′ are configured to contain hydrocarbon fluid and limit heat loss from the contained hydrocarbon fluid. The soaker vessel 6′ can include an active heater element (such as heat tape or a heating coil) that is disposed between thermally-insulative material and the vessel wall. A plurality of soaker vessels can be disposed downstream of the plurality of heaters.

FIGS. 9A and 9B show another configuration where the flow is divided between four traveling wave structures 1 that bring hydrocarbon fluid to the desired reaction temperature. The output of the four traveling wave structures 1 flows through four corresponding soaker sections 6 and then the flow is combined into two soaker vessels 6′, where the heated hydrocarbon fluid is allowed to remain for the desired average residence time. In this case, the outputs of the two pairs of soaker sections 6 each flows to a corresponding soaker vessel 6′.

In either example, the microwave delivery system, coupling, and impedance matching follow the descriptions above.

One advantage of the reactor design is rapid internal heating, or equivalently volumetric heating, of the hydrocarbon liquid while maintaining relatively cool temperatures on the walls of the fluid flow line in the heater section, which, in the present disclosure, is the traveling wave structure. Insulation or/and heat can be applied to the exterior of the traveling wave structure 1 in order to reduce heat loss to the surroundings by radiation thus reducing energy input requirements. The soaker section(s) 6 provide relatively accurate control over the level and the uniformity of the temperature profile for facilitating permanent visbreaking.

It is contemplated that the hydrocarbon fluid will flow at a controlled flow rate through the apparatus during the visbreaking process as described herein. In other embodiments, valves and pumps can be configured to control the hydrocarbon fluid flow such that it remains stationary within the apparatus during the visbreaking process.

Contrary to conventional heating techniques, the visbreaking of the hydrocarbon fluid by heating through microwave radiation results in localized heating through the oscillation of molecules in the hydrocarbon fluid, which results in heating the hydrocarbon fluid from within. This internal heating prevents thermally driven fouling from occurring on the interior wall of the traveling wave structure 1 of the apparatus. The use of microwave heating also offers the advantage of more rapid heating of a targeted volume of hydrocarbon fluid and offers the potential for economically visbreaking smaller production volumes. The apparatus and methodology of visbreaking can be used to irreversibly reduce the viscosity of a variety of hydrocarbon fluids, such as heavy crude oil, other viscous crude oils, and bitumen.

The apparatus as described herein has a small footprint as compared to the traditional systems for upgrading heavy oil. The apparatus may be located at a wellsite or in a production field so that the heavy oil may be upgraded before it is transported from the wellsite or the production field. It is contemplated that the apparatus can be mounted on skids or trucks and brought to the wellsite or production field for use.

The transmission line 5 and/or traveling wave structure 1 of the apparatus as described herein can employ a cylindrical cross-sectional shape. Other cross-sectional shapes, such as rectangular cross-sectional shapes, can also be used for the transmission line 5 and/or traveling wave structure 1.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims.

What is claimed is:

1. An apparatus for heating a hydrocarbon fluid with electromagnetic radiation, comprising:
a traveling wave structure defining an interior chamber, wherein the traveling wave structure is configured to confine electromagnetic radiation within the interior chamber and to contain hydrocarbon fluid that is subject to heating by the electromagnetic radiation confined within the interior chamber of the traveling wave structure.

2. An apparatus according to claim 1, wherein the electromagnetic radiation is traveling wave electromagnetic radiation.

3. An apparatus according to claim 1, further comprising a coupler that supplies electromagnetic radiation to the traveling wave structure.

4. An apparatus according to claim 3, wherein the coupler is disposed at one end of the traveling wave structure opposite an inlet for introducing hydrocarbon fluid into the interior chamber of the traveling wave structure.

5. An apparatus according to claim 3, further comprising a transmission line that delivers electromagnetic radiation to the traveling wave structure via the coupler.

6. An apparatus according to claim 5, wherein the transmission line and the traveling wave structure are configured such that impedance of the transmission line matches impedance of the traveling wave structure.

7. An apparatus according to claim 5, further comprising a disk or wall of material that is transparent with respect to the electromagnetic radiation that is supplied to the traveling wave structure via the coupler, wherein the disk or wall is configured to block flow of hydrocarbon fluid from the traveling wave structure into the transmission line while allowing electromagnetic radiation to pass from the transmission line into the traveling wave structure.

8. An apparatus according to claim 1, further comprising a plurality of through-holes in the traveling wave structure that are configured to allow hydrocarbon fluid to exit the interior chamber of the traveling wave structure.

9. An apparatus according to claim 8, wherein the plurality of through-holes are configured to limit loss of electromagnetic radiation from the internal chamber of the traveling wave structure through the plurality of through-holes.

10. An apparatus according to claim 8, wherein the plurality of through-holes are disposed about the circumference of the traveling wave structure.

11. An apparatus according to claim 8, further comprising a collecting cell that surrounds the plurality of through-holes and is configured to collect hydrocarbon fluid that exits the traveling wave structure through the plurality of through-holes.

12. An apparatus according to claim 11, further comprising a soaker section that extends from the collecting cell.

13. An apparatus according to claim 1, further comprising a soaker section that is fluidly coupled to the interior chamber of the traveling wave structure.

14. An apparatus according to claim 13, wherein the soaker section is disposed downstream of the traveling wave structure and is configured to contain hydrocarbon fluid and limit heat loss from the contained hydrocarbon fluid.

15. An apparatus according to claim 13, wherein the soaker section includes a tube or pipe or vessel that contains the hydrocarbon fluid with thermally-insulative material that surrounds the tube or pipe or vessel.

16. An apparatus according to claim 13, wherein the soaker section includes an active heater element.

17. An apparatus according to claim 1, further comprising at least one temperature sensor that is configured to measure temperature of the hydrocarbon fluid contained in the interior chamber of the traveling wave structure.

18. An apparatus according to claim 1, further comprising mechanical means for controlling volume of the interior chamber of the traveling wave structure.

19. An apparatus according to claim 1, wherein the traveling wave structure is configured to produce a predetermined traveling wave pattern of the electromagnetic radiation at a predefined frequency.

20. An apparatus according to claim 19, wherein the predefined frequency lies in a frequency band between 0.1 GHz and 100 GHz.

21. An apparatus according to claim 19, wherein the traveling wave structure is configured to produce a predetermined traveling wave at a desired TM or TE mode.

22. An apparatus according to claim 1, wherein the hydrocarbon fluid is heated by the electromagnetic radiation confined within the interior chamber of the traveling wave structure to a desired temperature for visbreaking of the hydrocarbon fluid in order to irreversibly reduce viscosity of the hydrocarbon fluid.

23. An apparatus according to claim 22, wherein the desired temperature for visbreaking of the hydrocarbon fluid is in the range between 350° C. and 500° C.

24. An apparatus according to claim 1, wherein the hydrocarbon fluid is selected from the group consisting of crude oil, heavy oil, and bitumen.

25. An assembly for heating a hydrocarbon fluid with microwave radiation, comprising a plurality of heater sections each comprising the apparatus of claim 1.

26. An assembly according to claim 25, further comprising at least one electromagnetic radiation source for supplying the electromagnetic radiation to corresponding heater sections.

27. An assembly according to claim 25, further comprising at least one soaker section disposed downstream of the plurality of heater sections, wherein the soaker section is configured to contain hydrocarbon fluid and limit heat loss from the contained hydrocarbon fluid.

28. An assembly according to claim 27, wherein the at least one soaker section includes a tube or pipe or vessel that contains the hydrocarbon fluid with thermally-insulative material that surrounds the tube or pipe or vessel.

29. An assembly according to claim 27, wherein the at least one soaker section includes an active heater element.

30. An assembly according to claim 27, wherein a given soaker section is fluidly coupled to at least two heater sections.

31. An assembly according to claim 27, wherein the at least one soaker section comprises a plurality of soaker sections disposed downstream of the plurality of heater sections.
